(19) United States
(12) Patent Application Publication
(10) Pub. No.: US 2003/0133014 A1
(43) Pub. Date: Jul. 17, 2003

(54) Motor vehicle rearview camera system and hitch cover with display

(76) Inventor: David Mendoza, Commerce, CA (US)

Correspondence Address: L. Kenneth Rosenthal, 2173 San Tropez Court, Chino Hills, CA, 91709, US

(21) Appl. No.: 10/336,474

(22) Filed: Jan. 3, 2003

Related U.S. Application Data
(60) Provisional application No. 60/349,858, filed on Jan. 17, 2002.

(51) Int. Cl. H04N 7/18; H04N 9/47

(52) U.S. Cl. 348/148

(57) ABSTRACT

A rearview camera and display system for a motor vehicle which comprises a low light level, wide angle camera mounted securely in a hitch cover which receives power from the hitch power plug, and supplies said power and video signal with blind spot information to a display monitor located in the vicinity of the rear view mirror area near the driver. The secure and locked placement of camera and hitch cover in a substantially flush configuration with the rear of the motor vehicle greatly less the opportunity for damage to the invention due to rear moving accidents and vandalism.

### RELATED APPLICATION

This application claims priority of provisional patent application No. 60/349,858 filed Jan. 17, 2002.

### NOTICE OF COPYRIGHTS

A portion of the disclosure of this patent document contains material which is subject to copyright protection. The copyright owner has no objection to the facsimile reproduction by anyone of the patent disclosure, as it appears in the United States Patent and Trademark Office patent files or records, but otherwise reserves all copyright rights whatsoever.

### BACKGROUND OF THE INVENTION

1. Field of the Invention

The invention relates to a rearview camera system and hitch cover assembly for a motor vehicle, and a display system positioned at or near the rear view mirror adjacent to the driver.

2. Background of the Invention

The invention relates to a rearview camera system and display for larger motor vehicles such as SUVs (sports utility vehicles), vans, pick-up trucks, and certain trucks. The rearview camera system allows the driver to view directly behind the vehicle in the blind spot area, said areas which are not viewable with the standard mirror systems and other means provided by the vehicle manufacturer. The invention, which is easily and quickly installed, secure, and vandal and environmentally resistant, is a closed circuit television system specially adopted for said larger motor vehicles whose camera system is adapted for the 2 inch (measured on each of the four sides of the square hitch shape) or the like trailer hitch receiver (or simply motor vehicle tow hitch receiver), and whose display system is adapted for placement near or at the driver's rear view mirror.

Drivers often rely on limited views of conventional mirrors, windows, and instinct when moving in reverse. These limited views can be further reduced by taller passengers in the rear seats at night—low light conditions, and other distractions. According the National Highway Traffic Administration data there is a backing accident every 1.6 minutes in the United States, most of said accidents occurring because the driver does not see an obstacle. An average of 116 children are fatally injured in off-road backing crashes annually during the last ten years, and children between the ages of 1 to 4 represent 30 percent of all backing fatalities. Insurance surveys report that 27 percent of all automotive accidents occur in reverse. Other insurance reports indicate that even very slight rear moving accidents can require repair bills of several hundred to several thousand dollars, depending on the motor vehicle model and the nature of the accident.

Prior art rearview camera systems have several drawbacks. Certain rearview cameras are mechanically fastened under or near the rear bumper, on the inside or outside or the rear window, or by drilling holes in the motor vehicle rear door or key lock and attaching custom bracketry and/or holders which are different which each vehicle class, and are often not essentially flush with the rear vehicle surfaces. These types of installation often require skilled labor, special tools, and the necessity of dismantling interior panels, and may compromise the structure's mechanical strength. Such systems often comprise the interior and exterior appearance or viewability of the rear parts of the motor vehicle, and are often made inoperable by simple vandalism, very minor accidents, and common environmental factors.

Recently several auto manufacturers, including Ford, Infinity, and Acura, have announced built in rear view camera systems for selected 2003 models. These systems will work only on these 2003 car and truck models, and cannot be retrofitted to other cars and trucks, and are very expensive, often being viewable with the navigation system screen. Other manufacturers for displays are using the half silvered rearview mirror with LCD TV viewers.

No rear view camera systems in the prior art can be quickly, easily and securely mounted to the trailer hitch of most new and older motor vehicles equipped with said trailer hitch. No rear view camera systems in the prior art provide a vandal, minor accident, and environmentally resistant enclosure for the rear view camera system, typically without the need for any custom brackets or parts, or skilled labor or detailed knowledge of motor vehicle audio video systems.

### SUMMARY OF THE INVENTION

It is an object of an embodiment of the present invention to provide a closed circuit television system for viewing the blind spot area and other areas in back of the motor vehicle during the reverse movement of the motor vehicle and during other movements and times. The present invention comprises a hitch cover with camera, a color monitor mounted near the rear view mirror next to the driver, a power video cord for connecting the color monitor to the hitch cover with camera which is installed under the interior motor vehicle paneling, and means for providing electrical power to the camera and monitor, preferably through the hitch power receptacle adjacent to the hitch cover. With certain motor vehicle models, the power video cord may be run through the headliner system or partly under the motor vehicle on the outside.

It is a further object of an embodiment of the present invention to house a television camera in a hitch cover which is securely fitted into the hitch of the motor vehicle. The use of a hitch lock or other means secures the hitch cover and camera to the motor vehicle. It is a further object of an embodiment of the invention that the television and hitch cover are mounted substantially flush with the rear of the motor vehicle as to minimize the damage to the hitch cover and camera during a rear moving accident.

It is a further object of an embodiment of the invention to allow the installation to be accomplished in 15 to 30 minutes without special tools or extensive training to nearly all motor vehicles which possess a hitch in their rear area.

Other features and advantages of the invention will become apparent from the following detailed description, taken in conjunction with the accompanying drawings which illustrate, by way of example, various features of embodiments of the invention.

### BRIEF DESCRIPTION OF THE FIGURES

A detailed description of embodiments of the invention will be made with reference to the accompanying drawings, wherein like numerals designate corresponding parts in the several figures.

FIG. 1 is a perspective drawing of an embodiment of the invention, showing the relationship among the main parts of the invention.

FIG. 2 is an environment drawing of the installation of the invention in a motor vehicle.

### DETAILED DESCRIPTION OF THE PREFERRED EMBODIMENTS

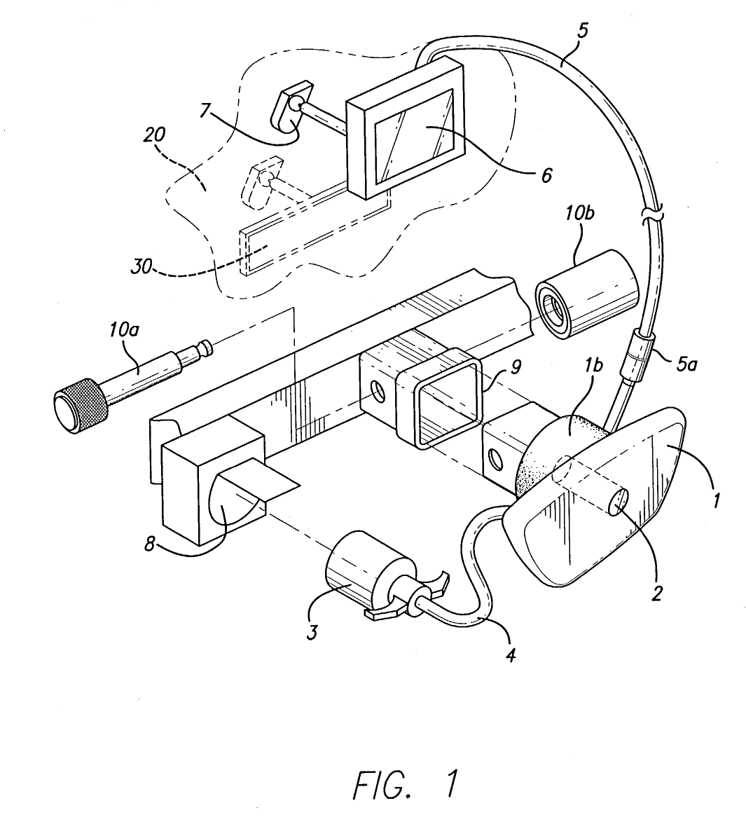

Referring to FIG. 1 hitch cover 1 houses camera 2. Preferably, hitch cover 1 is made from Aluminum 6061 grade and is finished with triple-chrome plate or black matte powder coat for aesthetic and environmental protection purposes. Camera 2 is preferably an approximately ⅓ inch CCD waterproof camera which is a wide angle optical system capable of viewing the large blind spot area behind the motor vehicle which can extend for the larger SUVs 4 to 5 feet or more in height from the ground and up to 20 feet or more back from the rear. Blind spots dimensions do vary depending on the motor vehicle model. Camera 2 also has the ability to operate in low light level conditions. Foam sleeve 1b prevents the rattling of hitch cover 1 with camera 2. Hitch cover 1 and camera 2 are fitted securely in motor vehicle hitch 9, and locked in place by hitch lock pin 10a which is fitted into hitch lock receptacle 10b. In addition other configurations of hitch cover locking systems may be employed using keys, one piece assemblies, or the like. Also, camera 2 may be stationary or controlled by motors (not shown) for changing views for selected motor vehicles.

Display monitor 6 is for viewing the output of camera 1. Preferably display monitor 6 is a 3.5 inch (screen diagonal measurement) LCD (liquid crystal display) with windshield mounting bracket 7 which may be mounted onto front windshield 20 either essentially above or below rear view mirror 30. In the first alternative display monitor 6 could be combined with rear view mirror 30 to form a single combination device for both standard rear view mirror viewing and observation of the output of the camera 2. In the second alternative the output of camera 2 could be feed into the motor vehicle electronics so as to its output could be viewed at the motor vehicle's navigation or TV screen by the driver and/or passengers in the front and rear seats. These later two alternatives would require knowledge of the motor vehicle's audio-video electronic systems, and may only be available on selected models.

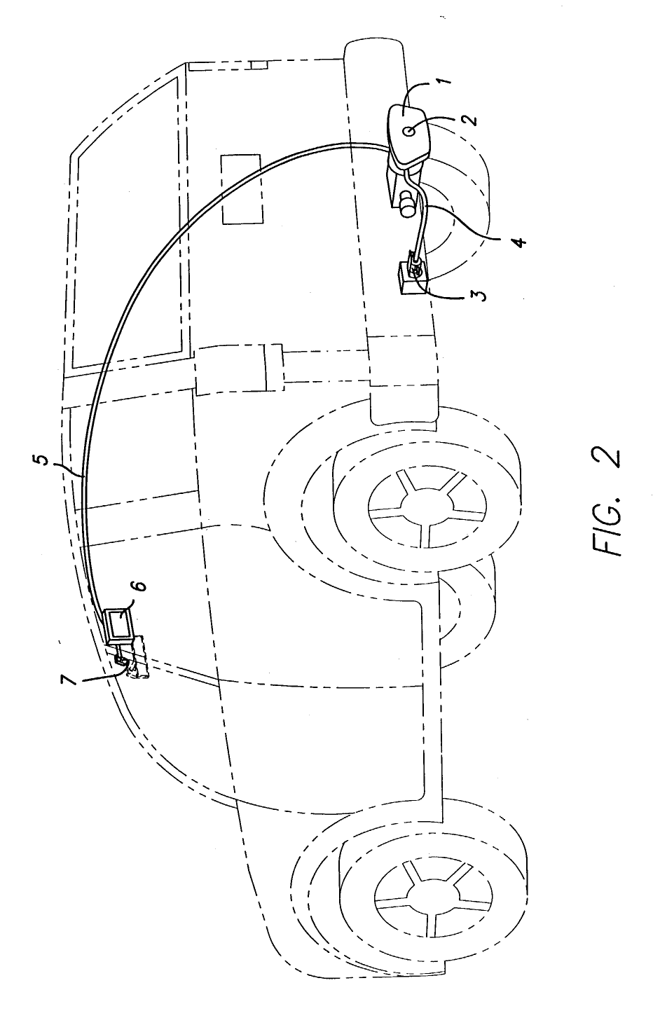

In the preferred embodiment camera 2 received its 12 volt electric power from power cord 4 which preferably is connected to the hitch power plug 8 which has an electric connector 3 at its end. In one preferred embodiment electric connector 3 may be a Pollak™ 7-way connector. Should the motor vehicle not be equipped with a hitch power plug 8, power cord 4 can be connected into the back-up light wiring of the motor vehicle. In both cases, the electronics of the display monitor present a picture whenever the vehicle is moving in a backwards motion (shifted in reverse). The driver of the motor vehicle may likewise engage a switch (not showed in FIGS. 1 and 2) on the display monitor 10 allowing said display monitor to present a picture when the motor vehicle is stopped or moving forward.

The power cord 4 attached to the hitch power plug 8 also supplies the display monitor 6 with electric power, preferably 12 volts, through the power and video cord 5. In addition, power and video cord 5 which is installed under the motor vehicle interior panels with typically no special equipment or training, supplies the video signal from the camera 2 to the display monitor 6. Also, power and video cord 5 may be equipped with a waterproof disconnect 5a for easy removal of hitch cover 1 and camera 2.

FIG. 2 depicts an environmental setup of the invention. Camera 2 housed in hitch cover 1 receives electrical power from power cord 4, and transmits said electrical power and camera 2 video signal via power and video cord 5 to display monitor 6 which is connected to motor vehicle 40 at the front windshield 20 via mounting bracket 7. Motor vehicle 40, rear view mirror 30, and front windshield 20 are shown in dotted lines, and form no part of the invention.

With the use of the invention, the driver is aided in backing and parking and accident prevention by the reduction of the rear blind spot area. Also, the low light level feature of camera 2 provides increased night rear visibility through its automatic low light level feature. In addition other embodiments of the invention could provide electronic power to the display monitor 6 and camera 2 with batteries, and video communication between the display monitor 10 and camera 2 could be accomplished in a wireless manner so as to alleviate the need for hardwire connections of these functions.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than by the foregoing description, and all changes which come within the meaning and range of equivalency of the claims are therefore intended to be embraced therein.

What is claimed is:

1. A rearview camera system and display for a motor vehicle comprising:
Camera means housed in a hitch cover which views the area behind a motor vehicle, and
Display monitor means positioned near the driver for viewing said area behind said motor vehicle while in motion or being stationary.

2. The rearview camera system and display of claim 1 wherein said camera means contains a waterproof wide angle optical system and a ⅓ inch CCD.

3. The rearview camera system and display of claim 1 wherein said camera means views a blind spot area measuring approximately up to 5 feet in height from the ground and approximately up to 20 feet from the rear of said motor vehicle.

4. The rearview camera system and display of claim 1 wherein said camera means has the capability to operate at low light levels.

5. The rearview camera system and display of claim 1 where said camera means and said hitch cover are securely mounted to the hitch of a motor vehicle with a hitch lock and foam sleeve.

6. The rearview camera system and display of claim 5 wherein said hitch cover and said camera are mounted nearly flush with the back of said motor vehicle.

7. The rearview camera system and display of claim 1 where said display monitor means is a 3.5 inch screen mounted in the vicinity of the rear view mirror of said motor vehicle.

8. The rearview camera system and display of claim 7 wherein said 3.5 inch screen is mounted on said motor vehicle's windshield.

9. The rearview camera system of claim 1 wherein said camera means and said display monitor means receive electrical power from the hitch power plug.

10. The rearview camera system of claim 1 wherein said camera means and said display monitor means receive electrical power from the back-up light wiring of said motor vehicle.

11. The rearview camera system and display of claim 9 wherein said camera means supplies a video signal with power and video cord to said display monitor, and said power and video cord is installed under the motor vehicle interior panels.

12. The rearview camera system and display of claim 5 wherein said hitch of the motor vehicle measures approximately 2 inches.

13. The rearview camera system and display of claim 1 wherein said camera means and said display monitor means operate while said motor vehicle is moving forward, in reverse, or in a stationary position.

14. A rearview camera system and display for a motor vehicle comprising:
A camera mounted in a hitch cover, said hitch cover secured to the hitch of said motor vehicle,
A display monitor which allows the driver to view the blind spot area and other areas behind said motor vehicle,
A power cord connected to said camera which receives electrical power from the hitch power plug, and
A power and video cord installed under the motor vehicle interior panels which connects to said camera and transfers power and video signal to said display monitor.

15. The rearview camera system and display of claim 14 wherein said camera views the blind spot area which measures up to 5 feet in height from the ground and up to 20 feet from the rear of said motor vehicle.

16. The rearview camera system and display of claim 14 wherein said display monitor is a 3.5 inch liquid crystal display with windshield mounting bracket for attachment to front windshield.

17. The rearview camera system and display of claim 14 wherein said camera and said hitch cover are mounted essentially flush with the rear of said motor vehicle.

18. The rearview camera system and display of claim 14 wherein said camera operates in low light level conditions.

19. The rearview camera system and display of claim 14 wherein said camera and said display monitor operate while said motor vehicle is moving forward, in reverse, or in a stationary position.

20. The rearview camera system and display of claim 14 where said hitch of said motor vehicle is approximately 2 inches.

21. The rearview camera system of claim 14 wherein said power and video cord contains a waterproof disconnect for quick removal of said camera and said hitch cover.
